(19) United States
(12) Patent Application Publication
(10) Pub. No.: US 2025/0157768 A1
(43) Pub. Date: May 15, 2025

(54) ELECTRIC CIRCUIT BREAKER DEVICE

(71) Applicant: Daicel Corporation, Osaka (JP)

(72) Inventors: Katsuhisa FUJITOU, Tokyo (JP); Ryouta KOUSHIMA, Tokyo (JP)

(73) Assignee: Daicel Corporation, Osaka (JP)

(21) Appl. No.: 18/838,694

(22) PCT Filed: Sep. 26, 2022
(86) PCT No.: PCT/JP2022/035599

§ 371 Date: Aug. 15, 2024

(30) Foreign Application Priority Data
Feb. 15, 2022 (JP) 2022-021604

(51) Int. Cl. H01H 39/00

(52) U.S. Cl. CPC H01H 39/006; H01H 2039/008

(57) ABSTRACT

An electric circuit breaker device includes: an igniter provided in a housing; a projectile formed in the housing and disposed in an accommodating space extending in one direction; a conductor piece provided in the housing and forming a part of an electric circuit, the conductor piece having a cutoff portion; and an impact absorbing member disposed in an arc-extinguishing region of the accommodating space, the arc-extinguishing region being located on a side opposite to the projectile across the cutoff portion prior to actuation of the igniter and being configured to receive the cutoff portion cut off by the projectile, the impact absorbing member being formed from a resin material that is modified by heat accompanying actuation of the igniter, the impact absorbing member having flexibility, and being configured to absorb an impact in a case where the cutoff portion having been cut off collides.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system in which the electric circuit is mounted, thereby urgently interrupting the continuity of the electric circuit. Electric circuit breaker devices have been proposed in which, according to one aspect thereof, a projectile is moved at high speed by energy applied from an igniter or the like to forcibly and physically cut a conductor piece that forms a portion of an electric circuit (refer to Patent Documents 1 and 2 and the like, for example). Further, in recent years, electric circuit breaker devices applied to electric vehicles equipped with a high-voltage power source are becoming increasingly important.

### CITATION LIST

### Patent Document

Patent Document 1: US 2019/051478
Patent Document 2: WO 2020/093079 A

### SUMMARY OF INVENTION

### Technical Problem

In an electric circuit breaker device, when a cutoff portion of a conductor piece cut off during actuation bounces around inside the housing, the conductor is evaporated by arc discharge during cutoff and may be diffused to decrease the insulation resistance value after actuation.

The technology of the present disclosure has been made in view of the above circumstances, and an object thereof is to provide an electric circuit breaker device that suppresses a decrease in an insulation resistance value after actuation.

### Solution to Problem

To solve the above problem, an electric circuit breaker device according to an embodiment of the present disclosure includes:
an igniter provided in a housing;
a projectile formed in the housing and disposed in an accommodating space extending in one direction, the projectile configured to be projected along the accommodating space by energy received from the igniter;
a conductor piece provided in the housing and forming a part of an electric circuit, the conductor piece having, as a part of the conductor piece, a cutoff portion configured to be cut off by the projectile moving due to energy received from the igniter, the cutoff portion being disposed crossing the accommodating space; and
an impact absorbing member disposed in an arc-extinguishing region of the accommodating space, the arc-extinguishing region being located on a side opposite to the projectile across the cutoff portion prior to actuation of the igniter and being configured to receive the cutoff portion cut off by the projectile, the impact absorbing member being formed from a modified resin material that is modified by heat accompanying actuation of the igniter, the impact absorbing member having flexibility, and being configured to absorb an impact in a case where the cutoff portion having been cut off collides.

The electric circuit breaker device may further include a coolant material disposed in the arc-extinguishing region.

In the electric circuit breaker device, the impact absorbing member may be disposed inside the coolant material.

In the electric circuit breaker device, the impact absorbing member may be disposed between the housing defining the arc-extinguishing region and the coolant material.

In the electric circuit breaker device, the impact absorbing member may be disposed in a ring shape or an arc shape along an inner wall surface of the housing.

In the electric circuit breaker device, the impact absorbing member may be a synthetic resin containing silicone.

### Advantageous Effects of Invention

According to an embodiment of the present disclosure, it is possible to provide an electric circuit breaker device that suppresses a decrease in an insulation resistance value after actuation.

### BRIEF DESCRIPTION OF DRAWINGS

FIG. 1 is a view illustrating an internal structure of an electric circuit breaker device (hereinafter simply referred to as a “breaker device”) 1 according to an embodiment.

FIG. 2 is a top view of a conductor piece according to the embodiment.

FIG. 3 is a view illustrating actuation situations of the breaker device according to the embodiment.

FIG. 4 is a view illustrating an internal structure of a breaker device according to a first modification.

FIG. 5 is a view illustrating an internal structure of a breaker device according to a second modification.

FIG. 6 is a cross-sectional view of a breaker device 1B taken along line B-B in FIG. 5.

FIG. 7 is a view illustrating an example in which an impact absorbing member having an arc shape is disposed along an inner circumferential surface of a side wall portion in a bottom container.

FIG. 8 is a view illustrating an internal structure of a breaker device according to a third modification.

### DESCRIPTION OF EMBODIMENTS

### First Embodiment

An electric circuit breaker device according to an embodiment of the present disclosure will be described below with reference to the drawings. Note that each of the configurations, combinations thereof, and the like in the embodiments are examples, and various additions, omissions, substitutions, and other changes of the configurations may be made as appropriate without departing from the spirit of the present disclosure. The present disclosure is not limited by the embodiments and is limited only by the claims.

### Configuration

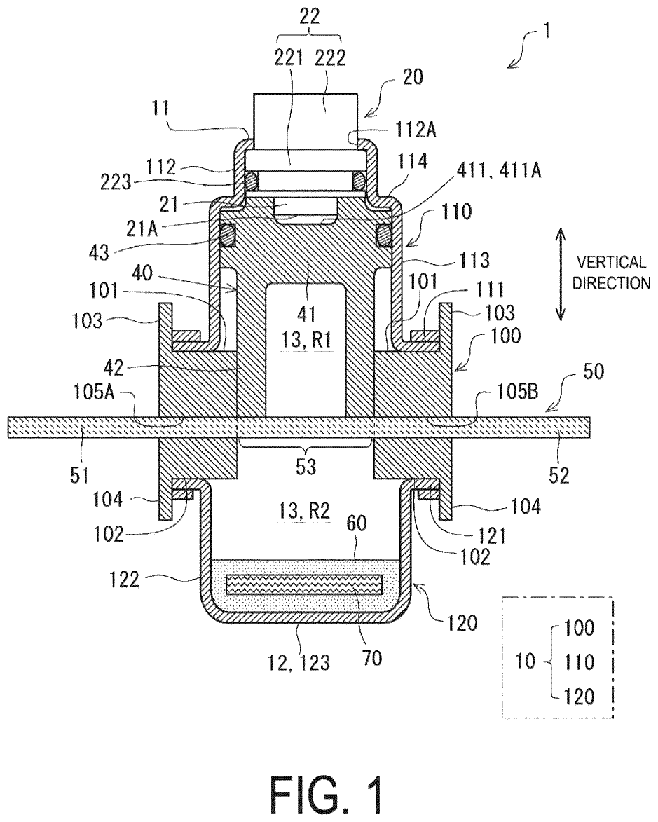

FIG. 1 is a view illustrating an internal structure of an electric circuit breaker device (hereinafter simply referred to as the “breaker device”) 1 according to an embodiment. The breaker device 1 is a device that interrupts an electric circuit included in a vehicle, an electric home appliance, a photovoltaic system, or the like when an abnormality occurs in the electric circuit or in a system including a battery (lithium ion battery, for example) of the electric circuit, thereby suppressing great damage. In the present specification, a cross section along a height direction (direction in which an accommodating space 13 described later extends, also called an extending direction below) illustrated in FIG. 1 is called a longitudinal cross section of the breaker device 1, and a cross section in a direction orthogonal to the height direction is called a transverse cross section of the breaker device 1. FIG. 1 illustrates a state prior to actuation of the breaker device 1.

The breaker device 1 includes a housing 10 as an outer shell member, an igniter 20, a projectile 40, a conductor piece 50, a coolant material 60, and an impact absorbing member 70. The housing 10 has the accommodating space 13 extending in one direction, for example, from a first end portion 11 on an upper end side to a second end portion 12 on a lower end side. This accommodating space 13 is a space formed linearly, allowing the projectile 40 to move, and extends along a vertical direction of the breaker device 1. As illustrated in FIG. 1, the accommodating space 13 formed inside the housing 10 accommodates the projectile 40. However, in the present specification, the vertical direction of the breaker device 1 merely indicates a relative positional relationship among the elements in the breaker device 1 for convenience of description of the embodiment.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially prismatic outer shape. However, the shape of the housing body 100 is not particularly limited. The housing body 100 includes a cavity portion formed through the housing body 100 along the vertical direction. This cavity portion forms a portion of the accommodating space 13. Furthermore, the housing body 100 includes an upper surface 101 to which a flange portion 111 of the top holder 110 is fixed and a lower surface 102 to which a flange portion 121 of the bottom container 120 is fixed. In the present embodiment, an upper tubular wall 103 having a tubular shape is provided erected upward from the upper surface 101 on the outer circumferential side of the upper surface 101 in the housing body 100. In the present embodiment, the upper tubular wall 103 has a rectangular tubular shape, for example, but may have another shape. On the outer circumferential side of the lower surface 102 in the housing body 100, a lower tubular wall 104 having a tubular shape is provided suspended downward from the lower surface 102. In the present embodiment, the lower tubular wall 104 has a rectangular tubular shape, for example, but may have other shapes. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped cylindrical tubular shape with a hollow inside. The top holder 110 includes a small diameter cylinder portion 112 positioned on the upper side (first end portion 11 side), a large diameter cylinder portion 113 positioned on the lower side, a connection portion 114 connecting the small diameter cylinder portion 112 and the large diameter cylinder portion 113, and the flange portion 111 extending outward from a lower end of the large diameter cylinder portion 113. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper tubular wall 103 in the housing body 100. For example, the flange portion 111 may be integrally fastened to the upper surface 101 in the housing body 100 using a screw or the like, or may be fixed thereto by a rivet or the like, in a state of being disposed inside the upper tubular wall 103. Further, the top holder 110 may be bonded to the housing body 100 in a state where a sealant is applied between the upper surface 101 of the housing body 100 and a lower surface of the flange portion 111 in the top holder 110. This can increase airtightness of the accommodating space 13 formed in the housing 10. Further, instead of the sealant or in combination with the sealant, an O-ring may be interposed between the upper surface 101 of the housing body 100 and the flange portion 111 of the top holder 110 to increase the airtightness of the accommodating space 13.

The cavity portion formed inside the small diameter cylinder portion 112 in the top holder 110 functions as an accommodating space for accommodating a portion of the igniter 20 as illustrated in FIG. 1. Further, the cavity portion formed inside the large diameter cylinder portion 113 in the top holder 110 communicates with the cavity portion of the housing body 100 positioned below, and forms a portion of the accommodating space 13. The top holder 110 configured as described above can be formed from an appropriate metal member having excellent strength and durability, such as stainless steel or aluminum. However, the material forming the top holder 110 is not particularly limited. Also, for the shape of the top holder 110, the above aspect is an example and another shape may be adopted.

### Bottom Container

Next, the bottom container 120 will be described. The bottom container 120 has a substantially tubular bottomed shape with a hollow inside, and includes a side wall portion 122, a bottom wall portion 123 connected to a lower end of the side wall portion 122, and a flange portion 121 connected to an upper end of the side wall portion 122. The side wall portion 122 has, for example, a cylindrical tubular shape. The flange portion 121 extends outward from the upper end of the side wall portion 122. The contour of the flange portion 121 in the bottom container 120 has a substantially quadrangular shape that fits inside the lower tubular wall 104 in the housing body 100. For example, the flange portion 121 may be integrally fastened to the lower surface 102 in the housing body 100 using a screw or the like, or may be fixed thereto by a rivet or the like, in a state of being disposed inside the lower tubular wall 104. Here, the bottom container 120 may be bonded to the housing body 100 in a state where the sealant is applied between the lower surface 102 of the housing body 100 and an upper surface of the flange portion 121 in the bottom container 120. This can increase airtightness of the accommodating space 13 formed in the housing 10. Further, instead of the sealant or in combination with the sealant, an O-ring may be interposed between the lower surface 102 of the housing body 100 and the flange portion 121 of the bottom container 120 to increase the airtightness of the accommodating space 13.

Note that the above aspect regarding the shape of the bottom container 120 is an example, and another shape may be adopted. Further, the cavity portion formed inside the bottom container 120 communicates with the housing body 100 positioned above, and forms a portion of the accommodating space 13. The bottom container 120 configured as described above can be formed from an appropriate metal member having excellent strength and durability, such as stainless steel or aluminum. However, the material forming the bottom container 120 is not particularly limited. Further, the bottom container 120 may have a multilayer structure. For example, in the bottom container 120, an exterior portion facing the outside may be formed using an appropriate metal member having excellent strength and durability, such as stainless steel or aluminum, and an interior portion facing the accommodating space 13 may be formed using an insulating member such as a synthetic resin. Of course, the entire bottom container 120 may be formed using an insulating member.

As described above, the housing 10 in the embodiment includes the housing body 100, the top holder 110, and the bottom container 120 that are integrally assembled, and the accommodating space 13 extending in the direction from the first end portion 11 to the second end portion 12 is formed inside the housing 10. This accommodating space 13 accommodates the igniter 20, the projectile 40, a cutoff portion 53 in the conductor piece 50, the coolant material 60, the impact absorbing member 70, and the like, which will be described in detail below.

### Igniter

Next, the igniter 20 will be described. The igniter 20 is an electric igniter that includes an ignition portion 21 with an ignition charge, and an igniter body 22 including a pair of conduction pins (not illustrated) connected to the ignition portion 21. The igniter body 22 is surrounded by an insulating resin, for example. Further, tip end sides of the pair of conduction pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 positioned on the body portion 221. The igniter body 22 is fixed to the small diameter cylinder portion 112 by press-fitting, for example, the body portion 221 to an inner circumferential surface of the small diameter cylinder portion 112. Further, a constricted portion having an outer circumferential surface recessed as compared with other locations is annularly formed along a circumferential direction of the body portion 221 at an axially intermediate portion of the body portion 221. An O-ring 223 is fitted into this constricted portion. The O-ring 223 is formed from, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a cylindrical tubular shape covering sides of the conduction pins, allowing connection with a connector of a power source.

As illustrated in FIG. 1, the ignition portion 21 of the igniter 20 is disposed facing the accommodating space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of conduction pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current for igniting the ignition charge is supplied from the power source to the conduction pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodating space 13. More specifically, the combustion gas from the igniter cup is discharged into a recess 411 in a piston portion 41 (described later) of the projectile 40 disposed in the accommodating space 13.

### Projectile

Next, the projectile 40 will be described. The projectile 40 is formed from an insulating member such as a synthetic resin, for example, and includes the piston portion 41 and a rod portion 42 connected to the piston portion 41. The piston portion 41 has a substantially circular columnar shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The shape of the projectile 40 can be changed as appropriate according to the shape of the housing 10 and the like.

Further, the recess 411 having a circular columnar shape, for example, is formed in an upper surface of the piston portion 41. This recess 411 receives the ignition portion 21. A bottom surface of the recess 411 is formed as a pressure receiving surface 411A that receives energy received from the igniter 20 during actuation of the igniter 20. Further, a constricted portion having an outer circumferential surface recessed as compared with other locations is annularly formed along a circumferential direction of the piston portion 41 at an axially intermediate portion of the piston portion 41. An O-ring 43 is fitted into this constricted portion. The O-ring 43 is formed from, for example, rubber (silicone rubber, for example) or a synthetic resin, and functions to increase airtightness between an inner circumferential surface in the large diameter cylinder portion 113 and the piston portion 41.

The rod portion 42 of the projectile 40 is a rod-shaped member having an outer circumferential surface smaller in diameter than the piston portion 41, for example, and is integrally connected to a lower end side of the piston portion 41. A lower end surface of the rod portion 42 is formed as a cutting surface 421 for cutting off the cutoff portion 53 from the conductor piece 50 during actuation of the breaker device 1. Note that although the rod portion 42 in the present embodiment has a substantially cylindrical tubular shape, the shape thereof is not particularly limited, and can be changed in accordance with the shape and size of the cutoff portion 53 to be cut off from the conductor piece 50 during actuation of the breaker device 1. The rod portion 42 may have a columnar shape such as a circular column or a rectangular column, for example. Note that, in an initial position of the projectile 40 illustrated in FIG. 1, a region on a tip end side including the cutting surface 421 in the rod portion 42 of the projectile 40 is positioned in the cavity portion (forming a portion of the accommodating space 13) of the housing body 100. The diameter of the rod portion 42 is slightly smaller than the inner diameter of an inner circumferential surface of the housing body 100, for example, and the outer circumferential surface of the rod portion 42 is guided along the inner circumferential surface when the projectile 40 is projected.

As described in detail later, the projectile 40 configured as described above is projected from the initial position illustrated in FIG. 1 when the upper surface of the piston portion 41 including the pressure receiving surface 411A receives the energy from the igniter 20 during actuation of the igniter 20, and moves at high speed toward the second end portion 12 side (downward) along the accommodating space 13. Specifically, as illustrated in FIG. 1, the piston portion 41 of the projectile 40 is accommodated inside the large diameter cylinder portion 113 in the top holder 110, and is slidable in the axial direction along an inner wall surface of the large diameter cylinder portion 113. In the present embodiment, the piston portion 41 of the projectile 40 has a substantially circular columnar shape, but the shape thereof is not particularly limited. As the outer shape of the piston portion 41, an appropriate shape and size can be adopted in accordance with the shape and size of the inner wall surface of the large diameter cylinder portion 113.

### Conductor Piece

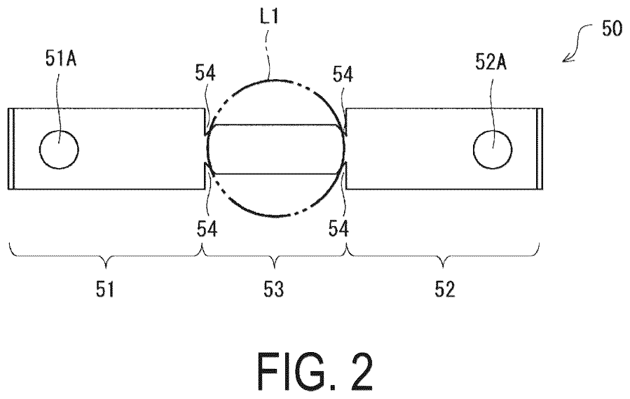

Next, the conductor piece 50 will be described. FIG. 2 is a top view of the conductor piece 50 according to the embodiment. The conductor piece 50 is a metal body having conductivity that constitutes a portion of the components of the breaker device 1 and, when the breaker device 1 is attached to a predetermined electric circuit, forms a portion of the electric circuit, and may be referred to as a bus bar. The conductor piece 50 can be formed from a metal such as copper (Cu), for example. However, the conductor piece 50 may be formed using a metal other than copper, or may be formed using an alloy of copper and another metal. Note that examples of metals other than copper included in the conductor piece 50 include manganese (Mn), nickel (Ni), and platinum (Pt).

In one aspect illustrated in FIG. 2, the conductor piece 50 is formed as an elongated flat plate piece as a whole, and includes a first connecting end portion 51 and a second connecting end portion 52 on both end sides, and the cutoff portion 53 positioned in an intermediate portion therebetween. Connection holes 51A, 52A are provided in the first connecting end portion 51 and the second connecting end portion 52 of the conductor piece 50, respectively. These connection holes 51A, 52A are used to connect with other conductors (lead wires, for example) in the electric circuit. Note that in FIG. 1, the connection holes 51A and 52A in the conductor piece 50 are not illustrated. The cutoff portion 53 of the conductor piece 50 is a portion forcibly and physically cut by the rod portion 42 of the projectile 40 and is cut off from the first connecting end portion 51 and the second connecting end portion 52 when an abnormality such as excessive current occurs in the electric circuit to which the breaker device 1 is applied. Notches (slits) 54 are formed at both ends of the cutoff portion 53 of the conductor piece 50, making it easy to cut and cut off the cutoff portion 53.

Various forms of the conductor piece 50 can be adopted, and the shape of the conductor piece 50 is not particularly limited. While, in the example illustrated in FIG. 2, surfaces of the first connecting end portion 51, the second connecting end portion 52, and the cutoff portion 53 form the same surface, the form is not limited thereto. For example, the conductor piece 50 may be connected such that the cutoff portion 53 is orthogonal to or inclined relative to the first connecting end portion 51 and the second connecting end portion 52. Further, the planar shape of the cutoff portion 53 of the conductor piece 50 is not particularly limited, either. Of course, the shapes of the first connecting end portion 51 and the second connecting end portion 52 of the conductor piece 50 are not particularly limited, either. Further, the notches 54 in the conductor piece 50 can be omitted as appropriate.

Here, a pair of conductor piece holding holes 105A and 105B are formed in the housing body 100 according to the embodiment. The pair of conductor piece holding holes 105A and 105B extend in a transverse cross-sectional direction orthogonal to the vertical direction (axial direction) of the housing body 100. More specifically, the pair of conductor piece holding holes 105A and 105B extend in a straight line with the cavity portion (accommodating space 13) of the housing body 100 interposed therebetween. The conductor piece 50 configured as described above is held in the housing body 100 in a state of being inserted through the pair of conductor piece holding holes 105A and 105B formed in the housing body 100. In the example illustrated in FIG. 1, the first connecting end portion 51 of the conductor piece 50 is held in a state of being inserted through the conductor piece holding hole 105A, and the second connecting end portion 52 is held in a state of being inserted through the conductor piece holding hole 105B. In this state, the cutoff portion 53 of the conductor piece 50 is positioned in the cavity portion (accommodating space 13) of the housing body 100. As described above, the conductor piece 50 attached to the housing body 100 is held orthogonally to the extending direction (axial direction) of the accommodating space 13 with the cutoff portion 53 crossing the accommodating space 13. Note that reference sign L1 illustrated in FIG. 2 denotes an outer circumferential position of the rod portion 42 positioned above the conductor piece 50 in a state of being attached to the housing body 100 of the breaker device 1. In the present embodiment, the conductor piece 50 is installed with the outer circumferential position L1 of the rod portion 42 substantially overlapping the positions of the notches 54 positioned at both ends of the cutoff portion 53. In the present embodiment, for example, since a transverse cross-sectional area of the accommodating space 13 is larger than a transverse cross-sectional area of the cutoff portion 53, a gap is formed on the side of the cutoff portion 53.

### Coolant Material

Next, the coolant material 60 disposed in the accommodating space 13 in the housing 10 will be described. Here, as illustrated in FIG. 1, prior to actuation of the breaker device 1 (igniter 20), the cutoff portion 53 of the conductor piece 50 in a state of being held in the pair of conductor piece holding holes 105A and 105B in the housing body 100 is horizontally laid crossing the accommodating space 13 of the housing 10. Hereinafter, within the accommodating space 13 of the housing 10 separated by the cutoff portion 53 of the conductor piece 50, a region (space) in which the projectile 40 is disposed is referred to as a “projectile initial arrangement region R1”, and a region (space) positioned on the opposite side of the projectile 40 is referred to as an “arc-extinguishing region R2”. Note that as described above, since the gap is formed on the side of the cutoff portion 53 disposed across the accommodating space 13, the projectile initial arrangement region R1 and the arc-extinguishing region R2 are not completely isolated from each other by the cutoff portion 53, but communicate with each other. Of course, depending on the shape and size of the cutoff portion 53, the projectile initial arrangement region R1 and the arc-extinguishing region R2 may be completely isolated from each other by the cutoff portion 53.

The arc-extinguishing region R2 of the accommodating space 13 is a region (space) for receiving the cutoff portion 53 cut off by the rod portion 42 of the projectile 40 projected during actuation of the breaker device 1 (igniter 20). In this arc-extinguishing region R2, the coolant material 60 serving as an arc-extinguishing material is disposed. The coolant material 60 is a coolant material for removing thermal energy of the arc generated and the cutoff portion 53 when the projectile 40 cuts off the cutoff portion 53 of the conductor piece 50 and cooling the arc and the cutoff portion 53, thereby suppressing arc generation during current cut off or thereby extinguishing (eliminating) the generated arc.

The arc-extinguishing region R2 of the breaker device 1 has significance as a space for receiving the cutoff portion 53 cut off from the first connecting end portion 51 and the second connecting end portion 52 of the conductor piece 50 by the projectile 40 and, at the same time, as a space for effectively extinguishing the arc generated when the projectile 40 cuts off the cutoff portion 53. Further, the coolant material 60 is disposed as an arc-extinguishing material in the arc-extinguishing region R2, and thus the arc generated when the cutoff portion 53 is cut off from the conductor piece 50 is effectively extinguished.

As one aspect of the embodiment, the coolant material 60 is solid. As one aspect of the embodiment, the coolant material 60 is formed from a shape retaining body. The shape retaining body herein is, for example, a material that can keep a constant shape when no external force is applied and can maintain integrity (does not come apart) when an external force is applied, even if deformation can occur. For example, examples of the shape retaining body include a fibrous body formed into a desired shape. In the present embodiment, the coolant material 60 is formed from a metal fiber that is a shape retaining body. Here, examples of the metal fiber forming the coolant material 60 include an aspect in which at least any one of steel wool or copper wool is included. However, the above aspects of the coolant material 60 are examples, and the coolant material 60 is not limited to the above aspects.

The coolant material 60 is formed into a substantially disk shape, for example, and is disposed at a bottom portion of the bottom container 120. In the present embodiment, the coolant material 60 is not an essential constituent element and may be omitted.

### Impact Absorbing Member

Next, the impact absorbing member 70 will be described. The impact absorbing member 70 is disposed in the accommodating space 13 of the housing 10. The impact absorbing member 70 of the present embodiment is a member disposed in the arc-extinguishing region R2 and has flexibility to absorb an impact in a case where the cutoff portion 53 of the conductor piece 50 cut off by the projectile 40 collides when the igniter 20 actuates. The impact absorbing member 70 is formed from, for example, a resin such as natural rubber or a synthetic resin including silicone. For example, the impact absorbing member 70 may absorb impact at the time of collision of the cutoff portion by having elasticity, such as that of rubber, or may absorb impact at the time of collision of the cutoff portion by having a structure including air bubbles, such as bubble wrap or sponge.

The impact absorbing member 70 may be modified by the arc generated by cutting off the cutoff portion 53 of the conductor piece 50 by the projectile 40 and the heat of the cutoff portion 53, and this modification may contribute to extinguishing the arc by consumption of thermal energy. As described above, the impact absorbing member 70 according to the present embodiment functions as an arc-extinguishing material similarly to the coolant material 60. Note that modification of the impact absorbing member 70 is mainly achieved by the heat of the arc, but, in addition to this, is affected by the heat generated when the cutoff portion 53 is cut off and the heat such as the combustion heat of ignition charge. The heat received from the ignition of the ignition charge to the completion of extinguishing the arc is referred to as heat accompanying actuation of the breaker device 1 or the igniter 20.

The impact absorbing member 70 of the present embodiment is formed from a synthetic resin containing silicone. Note that the impact absorbing member 70 is not limited to silicone, and may be made of another resin such as polyurethane, polyethylene, polypropylene, polyamide, or nitrile rubber. The impact absorbing member 70 may be at least partially modified by heat, and may be made of a composite material containing glass, ceramic filler, or the like.

The impact absorbing member 70 is formed in a sheet shape and is disposed inside the coolant material 60. In particular, in the present embodiment, the impact absorbing member 70 is disposed at the center of the coolant material 60 in the extending direction of the accommodating space 13. Therefore, in the impact absorbing member 70, the cutoff portion 53 cut off by the projectile 40 collides via the coolant material 60. At this time, the impact absorbing member 70 absorbs the impact, whereby the cutoff portion 53 is suppressed from bouncing around in the arc-extinguishing region R2, and the cutoff portion 53 can be effectively cooled by the coolant material 60.

### Operation

Next, details of operation when the breaker device 1 is actuated to interrupt the electric circuit will be described. As described above, FIG. 1 illustrates a state of the breaker device 1 prior to actuation (hereinafter also referred to as the “pre-actuation initial state”). In this pre-actuation initial state, in the projectile 40 in the breaker device 1, the piston portion 41 is positioned on the first end portion 11 side (upper end side) in the accommodating space 13, and the cutting surface 421 formed at the lower end of the rod portion 42 is set at an initial position positioned on the upper surface of the cutoff portion 53 in the conductor piece 50.

Furthermore, the breaker device 1 according to the embodiment further includes an abnormality detection sensor (not illustrated) that detects an abnormal state of a device (such as a vehicle, a power generation facility, or a power storage facility) to which an electric circuit to be interrupted is connected, and a control unit (not illustrated) that controls the actuation of the igniter 20. The abnormality detection sensor may be capable of detecting an abnormal state on the basis of a voltage or a temperature of the conductor piece 50 in addition to the current flowing through the conductor piece 50. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle. The control unit of the breaker device 1 is a computer capable of performing a predetermined function by executing a predetermined control program, for example. The predetermined function of the control unit may be realized by corresponding hardware. Then, when excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the conduction pins of the igniter 20 and actuates the igniter 20 based on the current value detected by the abnormality detection sensor. Here, the abnormal current may be a current value that exceeds a predetermined threshold value set for protection of a predetermined electric circuit. Note that the abnormality detection sensor and the control unit described above need not be included in the constituent elements of the breaker device 1, and may be included in a device separate from the breaker device 1, for example. Further, the abnormality detection sensor and the control unit are not essential components of the breaker device 1.

For example, when an abnormal current of the electric circuit is detected by an abnormality detection sensor that detects an abnormal current of the electric circuit, the control unit of the breaker device 1 actuates the igniter 20. That is, an actuating current is supplied from an external power source (not illustrated) to the conduction pins of the igniter 20, and as a result, the ignition charge in the ignition portion 21 is ignited and burns, generating a combustion gas. Then, the rupture surface 21A ruptures due to rise in pressure in the ignition portion 21, and the combustion gas of the ignition charge is discharged from the inside of the ignition portion 21 into the accommodating space 13.

Here, the ignition portion 21 of the igniter 20 is received in the recess 411 of the piston portion 41, and the rupture surface 21A of the ignition portion 21 is disposed facing the pressure receiving surface 411A of the recess 411 in the projectile 40. Therefore, the combustion gas from the ignition portion 21 is discharged to the recess 411, and the pressure (combustion energy) of the combustion gas is transmitted to the upper surface of the piston portion 41 including the pressure receiving surface 411A. As a result, the projectile 40 moves downward in the accommodating space 13 in the extending direction (axial direction) of the accommodating space 13.

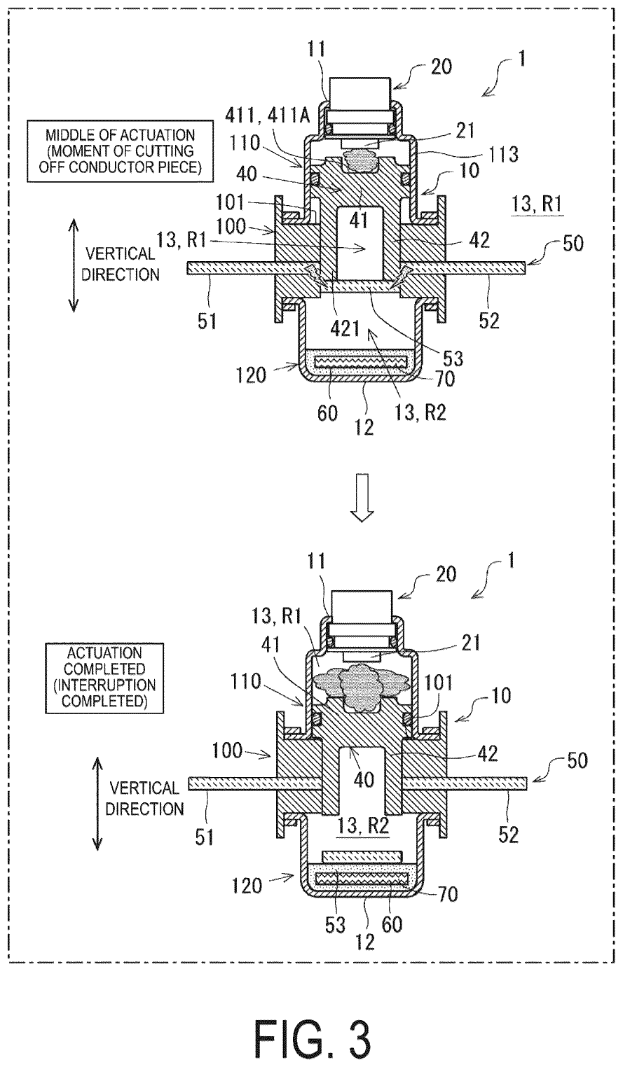

FIG. 3 is a view illustrating actuation situations of the breaker device 1 according to the embodiment. The upper half of FIG. 3 illustrates a situation in the middle of actuation of the breaker device 1, and the lower half of FIG. 3 illustrates a situation in which the actuation of the breaker device 1 is completed. As described above, upon actuation of the igniter 20, the projectile 40 having received the pressure (combustion energy) of the combustion gas of the ignition charge is vigorously pushed downward. As a result, the cutting surface 421 formed on the lower end side of the rod portion 42 presses and cuts, by shearing, the boundary portions between the first connecting end portion 51 and the cutoff portion 53 and between the second connecting end portion 52 and the cutoff portion 53 in the conductor piece 50. As a result, the cutoff portion 53 is cut off from the conductor piece 50. Note that as long as the projectile 40 can be moved smoothly in the extending direction (axial direction) of the accommodating space 13 when the igniter 20 is actuated, the shape and the dimensions of the projectile 40 can be freely determined, and the outer diameter of the piston portion 41 of the projectile 40 may be set to a dimension equal to the inner diameter of the large diameter cylinder portion 113 in the top holder 110, for example.

Then, as illustrated in the lower half of FIG. 3, the projectile 40 moves downward in the extending direction (axial direction) of the accommodating space 13 by a predetermined stroke until the lower end surface of the piston portion 41 abuts (collides with) the upper surface 101 of the housing body 100. Then, in this state, the cutoff portion 53 cut off from the conductor piece 50 by the rod portion 42 of the projectile 40 is received in the arc-extinguishing region R2 in which the coolant material 60 and the impact absorbing member 70 are disposed. As a result, the first connecting end portion 51 and the second connecting end portion 52 positioned on both ends of the conductor piece 50 are electrically disconnected, and the predetermined electric circuit to which the breaker device 1 is applied is forcibly interrupted.

In the breaker device 1 of the embodiment, the coolant material 60 is disposed in the arc-extinguishing region R2. Therefore, the cutoff portion 53 after being cut off that has been received in the arc-extinguishing region R2 can be rapidly cooled by the coolant material 60. Thus, when the cutoff portion 53 is cut off from the conductor piece 50 constituting a portion of the predetermined electric circuit by the projectile 40, even in a case where an arc is generated at the cut surface of the cutoff portion 53 of the conductor piece 50, the generated arc can be quickly and effectively extinguished.

Furthermore, in the breaker device 1, the impact absorbing member 70 is disposed inside the coolant material 60 in the arc-extinguishing region R2. Due to this, the rod portion 42 cuts off the cutoff portion 53 from the conductor piece 50, the cutoff portion 53 is pushed out to the bottom wall portion 123 side of the bottom container 120, and the impact absorbing member 70 absorbs the impact when colliding with the coolant material 60. Therefore, the cutoff portion 53 is suppressed from bouncing around in the arc-extinguishing region R2, diffusion of the conductor evaporated by the arc is suppressed eventually, and a decrease in the insulation resistance value after actuation can be suppressed. The impact absorbing member 70 is modified by the heat accompanying actuation of the igniter 20, and this modification consumes the heat of the arc, whereby the arc can be quickly and effectively extinguished. The impact absorbing member 70 is made of a material that is easily modified, such as decomposed or volatilized by heat, as compared with other resin materials such as those used for the housing 10 and the projectile 40, and such modification can effectively consume the heat of the arc. In the impact absorbing member 70 of the present embodiment, a component such as silica generated by thermal decomposition exhibits a high resistance value, and scattering of this component contributes to enhancement of the insulation properties after cutting.

As described above, according to the breaker device 1 of the present embodiment, the impact absorbing member 70 absorbs impact when the cutoff portion 53 collides, suppresses the cutoff portion 53 from bouncing around in the arc-extinguishing region R2, and can suppress a decrease in the insulation resistance value after actuation. According to the breaker device 1 of the present embodiment, the impact absorbing member 70 can cool the heat accompanying actuation of the igniter 20, suppress evaporation of the conductor piece 50 cut off, and suppress a decrease in the insulation resistance value after actuation. Furthermore, according to the breaker device 1, it is possible to suitably suppress the generation of a large spark or flame or the generation of a loud impact sound when the electric circuit is interrupted. Further, damage to the housing 10 and the like of the breaker device 1 caused by these can also be suppressed.

### First Modification

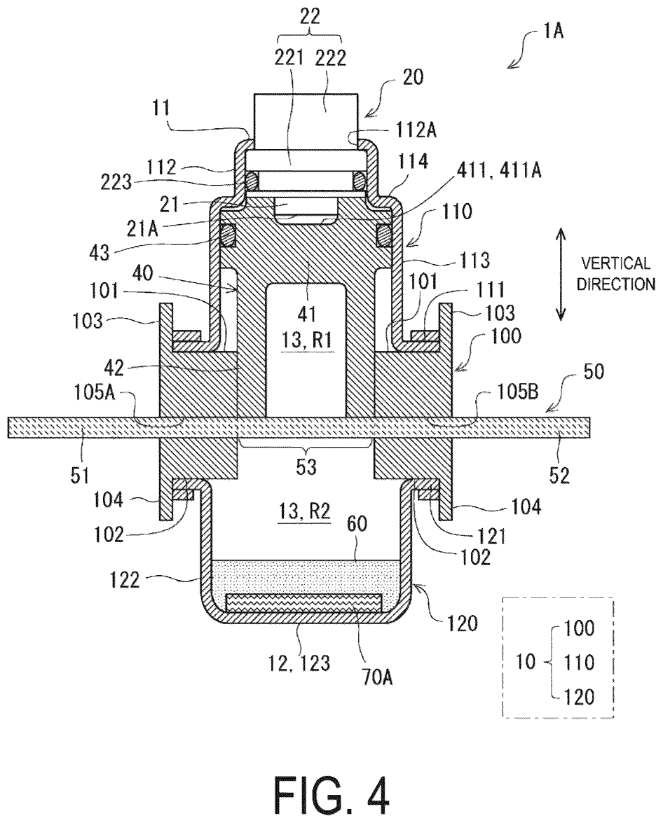

For the breaker device 1 according to the embodiment, various modifications can be adopted. For example, the shape, position, range, and the like of the coolant material 60 disposed in the arc-extinguishing region R2 of the accommodating space 13 can be changed as appropriate. For example, FIG. 4 is a view illustrating an internal structure of a breaker device 1A according to a first modification. The breaker device 1A of the first modification is different from the breaker device 1 illustrated in FIG. 1 in that an impact absorbing member 70A is disposed between the bottom wall portion 123 of the housing 10 and the coolant material 60. Note that since the other configurations are the same, identical elements are denoted by identical reference signs, and the description will not be repeated.

As illustrated in FIG. 4, in the first modification 1, the impact absorbing member 70A is disposed on the bottom wall portion 123 of the bottom container 120, and is located between the bottom wall portion 123 and the coolant material 60 in the extending direction of the accommodating space 13. Also in the configuration in which the impact absorbing member 70A is disposed between the bottom wall portion 123 and the coolant material 60 as described above, similarly to the above-described embodiment, the impact absorbing member 70A absorbs impact at the time of collision of the cutoff portion and suppresses the cutoff portion 53 from bouncing around in the arc-extinguishing region R2. Further, by being modified by heat accompanying actuation of the igniter 20 to consume the heat, the impact absorbing member 70A can suppress a decrease in the insulation resistance value after actuation.

### Second Modification

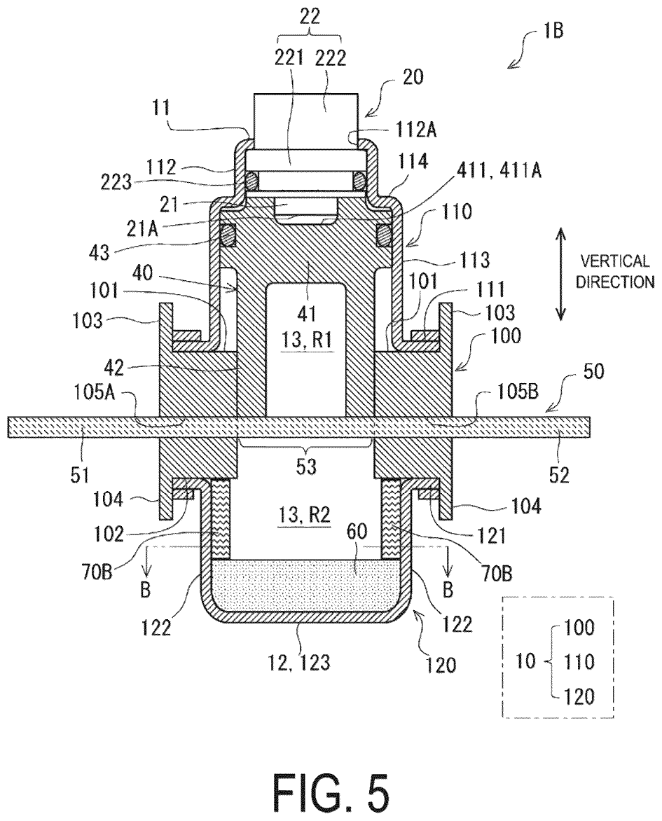

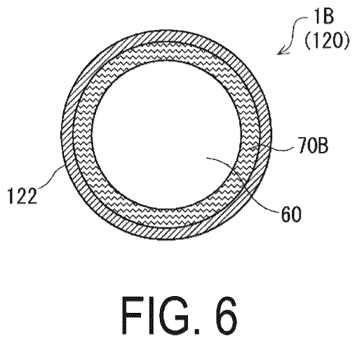

FIG. 5 is a view illustrating an internal structure of a breaker device 1B according to a second modification, and FIG. 6 is a cross-sectional view of the breaker device 1B taken along line B-B in FIG. 5. The breaker device 1B of the second modification is different from the breaker device 1 illustrated in FIG. 1 in terms of configuration, in which an impact absorbing member 70B is disposed along the side wall portion 122 of the housing 10. Note that since the other configurations are the same, identical elements are denoted by identical reference signs, and the description will not be repeated.

As illustrated in FIG. 6, in the second modification, the impact absorbing member 70B is formed in a ring shape and disposed along the inner circumferential surface of the side wall portion 122 defining the arc-extinguishing region R2. When the igniter 20 actuates and the cutoff portion 53 is cut off and moved to the side wall portion 122 side of the bottom container 120 by the projectile 40, the impact absorbing member 70B absorbs impact at the time of collision of the cutoff portion.

Also in the configuration in which the impact absorbing member 70B is disposed along the side wall portion 122 of the housing 10 as described above, similarly to the above-described embodiment, the impact absorbing member 70B absorbs an impact at the time of collision of the cutoff portion and suppresses the cutoff portion 53 from bouncing around in the arc-extinguishing region R2. Further, by being modified by heat accompanying actuation of the igniter 20 to consume the heat, the impact absorbing member 70B can suppress a decrease in the insulation resistance value after actuation.

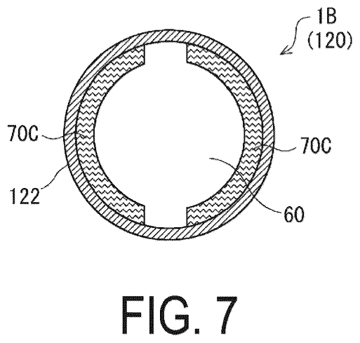

Note that the impact absorbing member 70B having a ring shape is disposed in the breaker device 1B of FIG. 6, but, in place of this, an impact absorbing member 70C having an arc shape may be disposed. FIG. 7 is a view illustrating an example in which the impact absorbing member 70C having an arc shape is disposed along the inner circumferential surface of the side wall portion 122 of the bottom container 120. The impact absorbing member 70C having an arc shape is provided on the side where the first connecting end portion 51 and the second connecting end portion 52 of the conductor piece 50 are disposed on the inner circumferential surface of the side wall portion 122 in a plan view as in FIG. 7.

The configuration in which the impact absorbing member 70C having an arc shape is disposed along the side wall portion 122 of the housing 10 as described above can also suppress a decrease in the insulation resistance value after actuation, similarly to the case where the impact absorbing member 70B in FIG. 6 is disposed. Furthermore, in combination with the above-described embodiment and the first modification, the second modification may be configured to include, in the arc-extinguishing region R2, the impact absorbing member 70 or the impact absorbing member 70A at the bottom wall portion 123 side and the impact absorbing member 70B or the impact absorbing member 70C of the side wall portion 122.

### Third Modification

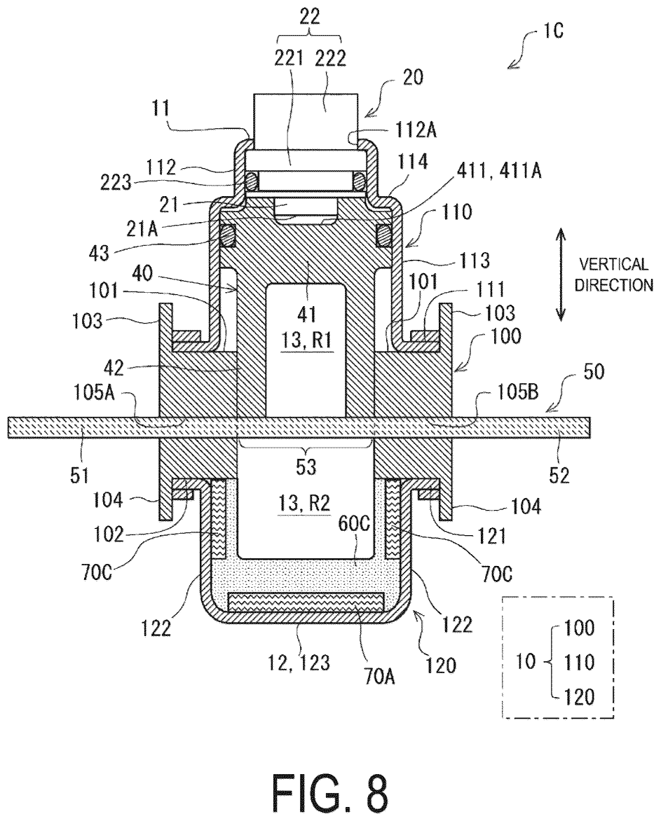

FIG. 8 is a view illustrating an internal structure of a breaker device 1C according to a third modification. The breaker device 1C of the third modification is different from the breaker device 1A illustrated in FIG. 4 in that a coolant material 60C is formed in a cup shape along an inner surface of the bottom container 120 and the impact absorbing member 70C is disposed along the side wall portion 122. Note that since the other configurations are the same, identical elements are denoted by identical reference signs, and the description will not be repeated.

The impact absorbing member 70C may have an arc shape similar to that in FIG. 7 in a plan view, or may have a ring shape similar to that in FIG. 6.

As described above, by disposing the impact absorbing member 70C along the side wall portion 122 and the coolant material 60C in combination, the breaker device 1C of the third modification can effectively cool the heat of the cutoff portion 53, and can further suppress a decrease in the insulation resistance value after actuation. Note that the impact absorbing member 70A disposed on the bottom wall portion 123 side may be omitted, as illustrated in FIG. 5.

While embodiments of the electric circuit breaker device according to the present disclosure have been described above, each of the aspects disclosed in the present specification can be combined with any other feature disclosed in the present specification.

### REFERENCE SIGNS LIST

1 Breaker device
10 Housing
100 Housing body
110 Top holder
111 Flange portion
112 Small diameter cylinder portion
112A Opening
113 Large diameter cylinder portion
114 Connection portion
120 Bottom container
121 Flange portion
122 Side wall portion
123 Bottom wall portion
13 Accommodating space
1A, 1B, 1C Breaker device
20 Igniter
21 Ignition portion
40 Projectile
41 Piston portion
42 Rod portion
50 Conductor piece
53 Cutoff portion
60, 60C Coolant material
70, 70A, 70B, 70C Impact absorbing member

1. An electric circuit breaker device comprising:
an igniter provided in a housing;
a projectile formed in the housing and disposed in an accommodating space extending in one direction, the projectile configured to be projected along the accommodating space by energy received from the igniter,
a conductor piece provided in the housing and forming a part of an electric circuit, the conductor piece having, as a part of the conductor piece, a cutoff portion configured to be cut off by the projectile moving due to energy received from the igniter, the cutoff portion being disposed crossing the accommodating space; and
an impact absorbing member disposed in an arc-extinguishing region of the accommodating space, the arc-extinguishing region being located on a side opposite to the projectile across the cutoff portion prior to actuation of the igniter and being configured to receive the cutoff portion cut off by the projectile, the impact absorbing member being formed from a resin material that is modified by heat accompanying actuation of the igniter, the impact absorbing member having flexibility, and being configured to absorb impact in a case where the cutoff portion having been cut off collides.

2. The electric circuit breaker device according to claim 1, further comprising a coolant material disposed in the accommodating space.

3. The electric circuit breaker device according to claim 2, wherein the impact absorbing member is disposed inside the coolant material.

4. The electric circuit breaker device according to claim 2, wherein the impact absorbing member is disposed between the housing defining the arc-extinguishing region and the coolant material.

5. The electric circuit breaker device according to claim 1, wherein the impact absorbing member is disposed in a ring shape or an arc shape along an inner wall surface of the housing.

6. The electric circuit breaker device according to claim 1, wherein the impact absorbing member is a synthetic resin containing silicone.

7. The electric circuit breaker device according to claim 2, wherein the impact absorbing member is disposed in a ring shape or an arc shape along an inner wall surface of the housing.

8. The electric circuit breaker device according to claim 3, wherein the impact absorbing member is disposed in a ring shape or an arc shape along an inner wall surface of the housing.

9. The electric circuit breaker device according to claim 4, wherein the impact absorbing member is disposed in a ring shape or an arc shape along an inner wall surface of the housing.

10. The electric circuit breaker device according to claim 2, wherein the impact absorbing member is a synthetic resin containing silicone.

11. The electric circuit breaker device according to claim 3, wherein the impact absorbing member is a synthetic resin containing silicone.

12. The electric circuit breaker device according to claim 4, wherein the impact absorbing member is a synthetic resin containing silicone.
